(19) United States
(12) Patent Application Publication
(10) Pub. No.: US 2009/0287450 A1
(43) Pub. Date: Nov. 19, 2009

(54) VISION SYSTEM FOR SCAN PLANNING OF ULTRASONIC INSPECTION

(75) Inventors: Marc Dubois, Fort Worth, TX (US); Thomas E. Drake, JR., Fort Worth, TX (US); Mark A. Osterkamp, Weatherford, TX (US); David L. Kaiser, Fort Worth, TX (US); Tho X. Do, Fort Worth, TX (US); Kenneth R. Yawn, Weatherford, TX (US)

Correspondence Address: BRACEWELL & GIULIANI LLP, P.O. BOX 61389, HOUSTON, TX, 77208-1389, US

(73) Assignee: LOCKHEED MARTIN CORPORATION, Bethesda, MD (US)

(21) Appl. No.: 12/122,158

(22) Filed: May 16, 2008

(51) Int. Cl. G01B 11/00

(52) U.S. Cl. 702/152

(57) ABSTRACT

A system and method for the analysis of composite materials. Structured light measurements are used to determine the 3-dimensional shape of an object, which is then analyzed to minimize the number of scans when performing laser ultrasound measurements.

### BACKGROUND OF THE INVENTION

1. Technical Field of the Invention

This invention generally relates to the field of non-destructive techniques for measurement of composite materials. Specifically, the invention relates to a method and system for correlating positional data with ultrasonic data.

2. Description of the Prior Art

In recent years, use of composite materials has grown in the aerospace and other commercial industries. Composite materials offer significant improvements in performance, however they are difficult to manufacture and thus require strict quality control procedures during manufacturing. Non-destructive evaluation (“NDE”) techniques have been developed as a method for the identification of defects in composite structures, such as, for example, the detection of inclusions, delaminations and porosities. Conventional NDE methods are typically slow, labor-intensive and costly. As a result, the testing procedures adversely increase the manufacturing costs associated with composite structures.

For parts having irregular surfaces, the measurement data is preferably correlated to positional data. For these parts, determination of the shape of the part is key to correlating the measurement to a position on the part. Prior art methods for scanning composite parts having irregular shapes required that the part being scanned be positioned on a table and secured in a known position, thereby providing a starting reference point for the scan. For large and/or irregularly shaped objects, the table or other means required to position a part are expensive and frequently specific for only one part.

According to the prior art methods, scanning of complex shaped parts required multiple scans from several different poses or views. These poses were typically manually selected by an experienced operator. These methods, however, had several shortcomings. Because of the complexity of the shape of many of the parts, it is frequently difficult to determine if the part has been overscanned or underscanned across its surface shape, or across adjacent parts when scanning an object that is made up of two or more parts. Additionally, the prior techniques relied upon the experience of the individual to select the number and placement of the poses. Thus, there exists a need for an improved method for scanning objects having a complex shape.

### SUMMARY OF THE INVENTION

A non-contact method and apparatus for determining the shape of an object and a method for correlating laser ultrasound measurements for the object are provided.

In one aspect. a method of analyzing an article is provided. The method includes the steps of: (a) scanning the article with a structured light system to obtain 3-dimensional information relating to the article; (b) processing the article 3-dimensional information to determine the minimum number of scans necessary to scan the surface of the article; (c) directing a laser beam at a surface of the article to create ultrasonic surface displacements, wherein the laser beam is directed at the surface of the article according to processed 3-dimensional information; (d) detecting the ultrasonic surface displacements; (e) correlating article 3-dimension information with the ultrasonic surface displacements; (f) processing the ultrasonic surface displacement data; and (g) correlating the 3-dimensional information and the processed ultrasonic surface displacements to provide coordinate measurements for the ultrasonic surface displacement data.

In certain embodiments, the article includes a composite material. In certain embodiments, scanning the article with a structured light system includes providing an structured light apparatus comprising a camera, a light beam producing element and means for moving structured light apparatus, projecting a light beam onto the surface of the article, operating the camera to receive the image of the light beam being projected onto the surface of the article, and moving the structured light apparatus to a next location until the entire surface of the article has been measured. In certain embodiments, the steps for detecting ultrasonic surface displacements at the surface of the article include generating a detection laser beam, directing the detection laser beam at the surface of the article, scattering the detection laser beam with the ultrasonic surface displacement of the article to produce phase modulated light, processing the phase modulated light to obtain data relating to the ultrasonic surface displacements at the surface, and collecting the data to provide information about the structure of the article. In certain embodiments, the article is an aircraft part. In certain embodiments, the article is an aircraft.

In certain embodiments, the steps further include executing a first computer implemented process to process the light detected from the article. In certain embodiments, the steps further include executing a second computer implemented process to obtain 3-dimensional information relating to the shape of the article. In certain embodiments, the steps further include executing a third computer implemented process to process the 3-dimensional information relating to the article and determine the minimum number of scans necessary to evaluate the article.

In another aspect, a method of evaluating aircraft parts in service is provided. The method includes the steps of scanning an as-made aircraft part with a structured light system to obtain article 3-dimensional information. The article 3-dimensional information is processed to determine the minimum number of scans necessary to scan the surface of the as-made aircraft part. A laser beam is directed at a surface of the as-made aircraft part to create ultrasonic surface displacements, wherein the laser beam is directed at the surface of the article according to processed 3-dimensional information to minimize the number of scans necessary to scan the surface of the as-made aircraft part. Ultrasonic surface displacements and measured and correlated with the as-made aircraft part 3-dimensional information. The as-made aircraft part 3-dimensional information is then compared with a known data set and the ultrasonic surface displacement data is processed. The known data set is correlated with the processed ultrasonic surface displacements to provide coordinate measurements for the ultrasonic surface displacement data of the as-made aircraft part. The as-made aircraft part 3-dimensional information and the ultrasonic surface displacement data are then stored. The as-made aircraft part is installed onto an aircraft and the installed aircraft part is scanned with a structured light system to obtain article 3-dimensional information. The article 3-dimensional information is processed to determine the minimum number of scans necessary to scan the surface of the installed aircraft part. A laser beam is directed at a surface of the installed aircraft part to create ultrasonic surface displacements, wherein the laser beam is directed at the surface of the article according to processed 3-dimensional information to minimize the number of scans necessary to scan the surface of the as-made aircraft part. A laser beam is directed at a surface of the installed aircraft part to create ultrasonic surface displacements. The ultrasonic surface displacements are detected and correlated with the installed aircraft part 3-dimensional information. The ultrasonic surface displacement data is processed and correlated to the known data set to provide coordinate measurements for the ultrasonic surface displacement data. The installed aircraft part 3-dimensional information and processed ultrasonic surface displacement data are then compared with the as-made aircraft part 3-dimensional information and processed ultrasonic surface displacement data.

In certain embodiments, the evaluation of the aircraft part includes the identification of a defect selected from the group consisting of delamination, cracks, inclusions, disbands, and combinations thereof.

### DETAILED DESCRIPTION OF THE INVENTION

The present invention includes multiple embodiments in different forms. Specific embodiments are described in detail and are shown in the figures, with the understanding that the present disclosure is to be considered an exemplification of the principles of the invention, and is not intended to limit the invention to those embodiments illustrated and described herein. It is to be fully recognized that the various teachings of the embodiments discussed herein may be employed separately, or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

Described herein are a non-contact method and apparatus for determining the shape of an object that includes composite materials, as well as a method for correlating laser ultrasound measurements for the object.

Structured Light

Structured light is one exemplary non-contact technique for the mapping of 3D composite materials, which involves the projection of a light pattern (for example, a plane, grid, or other more complex shape), at a known angle onto an object. This technique is useful for imaging and acquiring dimensional information.

Typically, with structured light systems, the light pattern is generated by fanning out or scattering a light beam into a sheet of light. When the sheet of light intersects with an object, a bright light can be seen on the surface of the object. By observing the line of light from an angle, typically at a detection angle which is different than the angle of the incident laser light, distortions in the line can be translated into height variations on the object being viewed. Multiple scans of views (frequently referred to as poses) can be combined to provide the shape of the entire object. Scanning an object with light can provide 3-D information about the shape of the object, wherein the 3-D information includes absolute coordinate and shape data for the object. This is sometimes referred to as active triangulation.

Because structured lighting can be used to determine the shape of an object, it can also help to both recognize and locate an object in an environment. These features make structured lighting useful in assembly lines implementing process control or quality control. Objects can be scanned to provide a shape of an article, which can then be compared against archived data. This advantage can allow for further automation of assembly lines, thereby generally decreasing the overall cost.

The beam of light projected onto the object can be observed with a camera or like means. Exemplary light detecting means include a CCD camera, or the like. A variety of different light sources can be used as the scanning source, although a laser is preferable for precision and reliability.

Structured light 3D scanners project a pattern of light on the subject and look at the deformation of the pattern on the subject. The pattern may be one dimensional or two dimensional. An example of a one dimensional pattern is a line. The line is projected onto the subject using either an LCD projector or a sweeping laser. The detection means, such as a camera, looks at the shape of the line and uses a technique similar to triangulation to calculate the distance of every point on the line. In the case of a single-line pattern, the line is swept across the field of view to gather distance information one strip at a time.

One advantage of a structured light 3D scanner is speed. Instead of scanning one point at a time, structured light scanners scan multiple points or the entire field of view at once. This reduces or eliminates the problem of distortion from the scanning motion. Some existing systems are capable of scanning moving objects in real-time.

In certain embodiments, the structured light system detection camera includes a filter designed to pass light corresponding only to a specified wavelength, such as the wavelength of the scanning laser. The detection camera is operable to detect and record the light image, and using various algorithms, determine the coordinate values corresponding to the image. In certain embodiments, the laser and the detection camera view the object from different angles.

The structured light system can also include a second camera, known as a texture camera, which is operable to provide a full image of the object.

In certain embodiments, the structured light system provides a series of data points to generate a point cloud corresponding to the shape of the object and the specific view of the object or part being scanned. The point clouds for each view or pose can then be merged to assemble a composite point cloud of the entire object or part. The individual point cloud data can then be transformed into specific cell coordinate systems.

Once the measured poses for each part have been assembled to provide a point cloud for the entire part, and the relative coordinates for the part have been determined, the data set corresponding to the part can then be registered. Registering the data set corresponding to the part provides a full complement of coordinate points for the part, and allows the data to be manipulated in space, thereby allowing the same part to be readily identified in later scans. Once a part has been registered, like parts are more easily identified and confirmed by comparing a subsequent scan against prior scans or confirmed CAD data. The registered scans can be collected to provide a database.

Laser Ultrasound

Laser ultrasound is a non-destructive evaluation technique for the analysis of solid materials to thereby provide data, such as, the presence of defects, and the like. In particular, because laser ultrasound is a non-destructive, non contact analytical technique, it can be used with delicate samples and samples having complex geometries. Additionally, laser ultrasound can be used to measure properties on large objects.

In laser ultrasound, pulsed laser irradiation causes thermal expansion and contraction on the surface being analyzed, thereby generating stress waves within the material. These waves create displacements on the material surface. Defects are detected when a measurable change in the displacement is recorded.

Laser detection of ultrasound can be performed in a variety of ways, and these techniques are constantly being improved and developed. There is no best method to use in general as it requires knowledge of the problem and an understanding of what the various types of laser detector can do. Commonly used laser detectors fall into two categories, interferometric detection (Fabry Perot, Michelson, time delay, vibrometers and others) and amplitude variation detection such as knife edge detectors.

Laser ultrasound is one exemplary method for inspecting objects made from composite materials. Generally, the method involves producing ultrasonic vibrations on a composite surface by radiating a portion of the composite with a pulsed generation laser. A detection laser beam can be directed at the vibrating surface and scattered, reflected, and phase modulated by the surface vibrations to produce phase modulated light. The phase modulated laser light can be collected by optical means and directed it for processing. Processing is typically performed by an interferometer coupled to the collection optics. Information concerning the composite can be ascertained from the phase modulated light processing, including the detection of cracks, delaminations, porosity, foreign materials (inclusions), disbonds, and fiber information.

In certain embodiments, a Mid-IR laser can be employed. Generally, the mid-IR laser provides larger optical penetration depth, improved signal to noise ratio to produce thermoelastic generation without producing thermal damage to the surface being analyzed, and shorter pulses.

One of the advantages of using laser ultrasound for objects with a complex shape, such as components used in the aerospace industry, is that a couplant is unnecessary and the complex shaped can be examined without the need for contour-following robotics. Thus, laser-ultrasound can be used in aerospace manufacturing for inspecting polymer-matrix composite materials. These composite materials may undergo multiple characterization stages during the preparation of the composite materials, one of which is the ultrasonic inspection by laser ultrasound. At some point during manufacturing these composites are preferably chemically characterized to ensure the resins used in forming the composite are properly cured. Additionally, it is important to confirm that the correct resins were used in the forming process. Because it is a non-destructive, non-contact technique, laser ultrasound is a preferable method of analysis. Typically, chemical characterization of composite materials typically involves obtaining control samples for infrared spectroscopy laboratory analysis.

Another of the advantages of employing the present method is the spectroscopic analysis described herein may be performed on the as-manufactured parts, rather than on a sample that has been taken from a particular part and analyzed in a laboratory. Additionally, the spectroscopic analysis techniques described herein can also be employed when the part is affixed to a finished product. In certain embodiments, the present method may be used on a finished product during the period of its useful life, i.e. after having been put into service and while it is affixed to an aircraft or other vehicle. For example, the spectroscopic analysis can occur on an aircraft part during the acceptance testing of the part prior to its assembly on the aircraft. Similarly, after being affixed onto the aircraft, a part can be analyzed using the spectroscopic analysis, prior to acceptance of the aircraft, or after the aircraft has been in service and during the life of the part or of the aircraft.

It should be noted that the present methods are not limited to final products comprising aircraft, but can include any single part or any product that includes two or more parts. Additionally, the laser ultrasonic system can be used to provide spectroscopic analysis of parts or portions of parts in hard to access locations. Not only can the present method determine the composition of a target object, such as a manufactured part, the method can determine if the object forming process has been undertaken correctly. For example, if the part is a composite or includes a resin product, it can be determined if the composite constituents, such as resin, have been properly processed or cured. Additionally, it can also be determined if a particular or desired constituent, such as resin, was used in forming the final product. The analysis can also determine if a coating, such as a painted surface, has been applied to an object, if the proper coating was applied to the surface and if the coating was applied properly.

Accordingly, recorded optical depth data of known composites provides a valid comparison reference to identify a material from measured ultrasonic displacement values and corresponding generation beam wavelength. As noted above, the identification with respect to the material of the part is not limited to the specific material composition, but can also include coatings, if the material had been properly processed, and percentages of compositions within the materials.

In a preferred embodiment, the optimum manner to scan an object or part is determined, including optimizing (i.e., using the fewest) the number of views or “poses” required for each complete scan, thereby minimizing overlap of the scans, and minimizing the need to reconstruct subsequent scans. In certain embodiments, the number of poses can be optimized according to measured data. In certain other embodiments, the minimum number of poses can be determined in view of the CAD data. In yet other embodiments, CAD data can be analyzed prior to scanning the object to determine the minimum the number of scans necessary to scan the entire surface of the object or part.

In a preferred embodiment, the object or part being scanned in initially scanned with a structured light system to obtain 3-dimensional information relating to the object or part being scanned. The light gathered by the camera receiving the image reflected off the object or part being scanned is processed to determine the most efficient manner to scan the part to obtain the laser ultrasonic data, i.e. to determine the minimum number of scans necessary to ensure scanning of the complete surface of the object or part being scanned. Once the minimum number of poses or scans has been determined, the object or part is then scanned with the laser ultrasound system, according to the methods described herein. The calculated minimum number of poses or scans can be confirmed by

In one aspect, the present invention provides an automated non-destructive technique and apparatus for correlating positional data and spectroscopic data of composite materials. An exemplary apparatus includes a laser ultrasound system, an analog camera and a structured light system. The laser ultrasound system can include a generation laser, a detection laser and optics means configured to collect light from the detection laser. In certain embodiments, the optics means can include an optical scanner, or the like. Exemplary generation lasers are known in the art. Exemplary detection lasers are known in the art.

The analog camera is a real-time monitor. The structured light system includes a laser for providing the structured light signal, an optional texture camera for providing panoramic images of the object being scanned, and a structured light camera. In certain embodiments, the structured light camera can include a filter designed to filter all light other than the laser light generated by the laser. The system is coupled to an articulated robotic arm having a rotational axis about the arm. The system also includes a pan and tilt unit coupling the structured light system to the robotic arm. The robotic arm preferably includes sensors allowing the system to be aware of the position of the arm and the attached cameras and lasers, thereby providing a self-aware absolute positioning system and eliminating the need for positioning the part being scanned on a referenced tool table. Additionally, the self-aware robotic system is suitable for scanning large objects that may be too large for analysis on a tool table. The system may be coupled to a computer that includes software operable to control the various cameras and to collect the data. In certain embodiments, the system may be a stationary system. In certain other embodiments, the system can be coupled to a linear rail. In certain other embodiments, the system can be mounted to a movable base or to a vehicle. The vehicle can be advantageously used to transport the system to a variety of locations.

In certain embodiments, the articulated robotic arm, and any means for moving the arm, can include means for preventing collision with objects in the general area, such as for example, tables or the like. Collision avoidance can be achieved by a variety of means, including programming the location of all fixed items and objects into the control system for the robotic arm or through the use various sensors. Typically, the robotic arm is locked out from occupying the space that is occupied by the part being scanned.

The method for scanning a part is described as follows. In a first step, an apparatus that includes a calibrated structured light system, laser ultrasound and robotic positioning system are provided. In a second step, a part is positioned in a predefined location for scanning. Generally, it is not necessary for the part to be positioned in a known location, as was necessary in the prior art, although it is advantageous for the part to be positioned in a defined location. In the third step, a part is scanned with a structured light system to provide 3-dimensional measurements and information relating to the part. Typically, the structured light camera includes a filter that filters the light such that only the laser light passes through the filter and is recorded. This can be accomplished by filtering out all wavelengths other than the wavelength produced by the laser. A line detection algorithm determines the coordinates for each individual scan over the object surface. The structured light system data is recorded. The system is then moved and repositioned to take the remaining images of the part to ensure the entire surface of the part being scanned. In a fourth step, after the entire surface of the part has been scanned, the structured light data is compiled to provide a 3-dimensional view of the object. In the fifth step, the structured light data processed to determine the minimum number of laser ultrasound scans or poses required to acquire data for the entire surface area of the part being scanned. In a sixth step, the laser ultrasound data is collected according to the poses determined based upon the 3-dimensional structured light information. The laser ultrasound data is correlated to the structured light data, and optionally, to a corresponding known data set, for example, CAD or archival data. In this manner, the laser ultrasound data can be mapped against the structure of the part, and trends in the presence, absence or formation of defects can be determined. Optionally, the laser ultrasound data can be analyzed to determine if the number and position of the scans determined by the laser ultrasound 3-dimensional information provides adequate coverage of the part being scanned.

Ultrasonic displacements are created on the target surface in response to the thermoelastic expansions. The amplitude of the ultrasonic displacement, at certain ultrasonic wavelengths, is directly proportional to the optical penetration depth of the generation laser beam into the target surface. The optical penetration depth is the inverse of the optical absorption of the target. Thus, in another embodiment of the present method, by varying the generation laser beam optical wavelength, an absorption band of the target material can be observed over a wavelength range of the generation beam.

The automated system is advantageous because it is much quicker than the prior art conventional system, which required that the operator select the pattern for scanning an article based upon knowledge and experience, without using calculated means for optimizing the process by minimizing the number of scans or poses. One major disadvantage to the prior art method is that each subsequent part having a like shape was required to be positioned in the exact same manner in order to provide data suitable for comparison, such as a for preparing a database for later comparison and compilation. In contrast, with the present system, the part is initially scanned with the structured light system, thereby providing data regarding the shape and allowing the object or part being scanned to be positioned in any manner as each part is individually scanned to determine the scanning pattern resulting in the minimum number of individual scans or poses. In certain embodiments, the present system is capable of scanning parts at up to 5 times faster than the prior art methods, and in preferred embodiments, the present system is capable of scanning parts at up to 10 times faster than the prior art methods. Increased rate of data acquisition provides for increased throughput of parts.

As noted previously, advantages to mapping the laser ultrasound data to the CAD data, or to a registered structure, include improved inspection efficiency due to the use of a verified structure and verification that the entire surface of the part is being scanned. Additionally, by correlating the ultrasound data to the coordinate data for the part, archiving of the part data is simplified as is the correlation of a part to be scanned in the future.

Laser ultrasound is useful for measuring other general material characteristics such as porosity, foreign materials, delaminations, porosity, foreign materials (inclusions), disbands, cracks, and fiber characteristics such as fiber orientation and fiber density, part thickness, and bulk mechanical properties. Thus, another advantage of the present method is a laser ultrasound detection system can perform target spectroscopic analysis while at the same time analyzing the bulk material for the presence of defect conditions. In addition to the savings of time and capital, a the present method provides more representative spectroscopic analysis as the analysis is performed on the entire surface of the object itself, rather than corresponding to a test coupon or control sample. As noted above, the scan can be performed on a manufactured part by itself, the part affixed to a larger finished product, or the final finish assembled product as a whole.

In certain embodiments, CAD data may be available for the object being analyzed. In these embodiments, the 3D positional data generated by the structured light system can be compared against and/or overlayed with the CAD data. This can be used as a quality control procedure to verify the manufacturing process. In other embodiments, the structured light data can be overlayed with the CAD data to provide confirmation of the part. Data that is collected with the structured light system can be used to provide a data cloud corresponding to the 3D structure of the object. Based upon calibration techniques used for the system, an absolute data cloud can be produced. The data cloud can then be oriented onto the CAD drawing, thereby providing correlation between the structured light data and the CAD data. The laser ultrasound data, which is preferably collected at the same time as the structured light data, and correlated to individual points on the surface of the object, can then be projected or mapped onto the CAD data to provide absolute coordinate data for the laser ultrasound data.

In certain embodiments, the apparatus can include a second camera, such as a texture camera. The texture camera generally captures full images of the object, and can be used for part recognition purposes. Unlike the structured light camera, the texture camera image is not filtered to remove the object from the image. While the structured light data provides a virtual surface of the part, the texture camera can provide an actual image of the object, which can be used in conjunction with the structured light and laser ultrasound data. In this manner, both the structured light data and the CAD data can be compared with the visual image provided by the texture camera. Additionally, the texture camera can provide a view of the part being scanned to the operator or for archival purposes.

Preferably, the structured light system is calibrated prior to performing the scan of the object. Calibration is necessary to ensure accuracy in the measurement and preparation of the coordinate data relating to the object being scanned. In certain embodiments, the system is calibrated locally, i.e., in relation to the tilt and pivot mechanism, by scanning an object having a known shape with the structured light system.

As understood by one of skill in the art, scanning of parts having complex shapes may require multiple scans. In one embodiment, the scans are conducted such that scans overlap at seams or edges of the part. In another embodiment, the scans are performed to purposely overlap in certain areas of the part.

Registration and comparison of the structured light data, against either CAD data or prior scans of similar or the same part, can help to ensure that 100% of the surface area is scanned with minimal overlap, or with overlap in the critical areas of the part. Additionally, registration allows for features and/or defects to be scanned and compared across multiple parts. This allows problem areas to be analyzed and solutions to be developed for the prevention of future defects. Additionally, storage of the data allows for parts being repaired to be compared with the “as constructed” data set.

For smaller parts having a complex shape, a tooling table can be used which includes pegs and posts to provide the necessary alignment cues for the structured light system. However, use of the tooling table as a base and support for the part being examined requires prior knowledge of the shape of the part, as well as a beginning reference point for the part.

As used herein, the terms about and approximately should be interpreted to include any values which are within 5% of the recited value. Furthermore, recitation of the term about and approximately with respect to a range of values should be interpreted to include both the upper and lower end of the recited range.

While the invention has been shown or described in only some of its embodiments, it should be apparent to those skilled in the art that it is not so limited, but is susceptible to various changes without departing from the scope of the invention.

We claim:

1. A method of analyzing an article comprising the steps of:
scanning the article with a structured light system to obtain 3-dimensional information relating to the article;
processing the article 3-dimensional information to determine the minimum number of scans necessary to scan the surface of the article;
directing a laser beam at a surface of the article to create ultrasonic surface displacements, wherein the laser beam is directed at the surface of the article according to processed 3-dimensional information;
detecting the ultrasonic surface displacements;
correlating article 3-dimension information with the ultrasonic surface displacements;
processing the ultrasonic surface displacement data; and
correlating the 3-dimensional information and the processed ultrasonic surface displacements to provide coordinate measurements for the ultrasonic surface displacement data.

2. The method of claim 1 further comprising positioning the article for evaluation.

3. The method of claim 1 wherein the article comprises a composite material.

4. The method of claim 1 wherein scanning the article with a structured light system comprises:
providing an structured light apparatus comprising a camera, a light beam producing element and means for moving structured light apparatus;
projecting a light beam onto the surface of the article;
operating the camera to receive the image of the light beam being projected onto the surface of the article; and
moving the structured light apparatus to a next location until the entire surface of the article has been measured.

5. The method of claim 1 wherein the steps for detecting ultrasonic surface displacements at the surface of the article comprise:
generating a detection laser beam;
directing the detection laser beam at the surface of the article;
scattering the detection laser beam with the ultrasonic surface displacement of the article to produce phase modulated light;
processing the phase modulated light to obtain data relating to the ultrasonic surface displacements at the surface; and
collecting the data to provide information about the structure of the article.

6. The method of claim 1 wherein the known data set is CAD data.

7. The method of claim 1 further comprising calibrating the structured light system prior to measuring the dimensions of the article.

8. The method of claim 1 wherein the article is an aircraft part.

9. The method of claim 1 wherein the article is an aircraft.

10. The method of claim 1 further comprising executing a first computer implemented process to process the light detected from the article.

11. The method of claim 10 further comprising executing a second computer implemented process to obtain 3-dimensional information relating to the shape of the article.

12. The method of claim 10 further comprising executing a third computer implemented process to process the 3-dimensional information relating to the article and determine the minimum number of scans necessary to evaluate the article.

13. A method of evaluating aircraft parts in service comprising:
scanning an as-made aircraft part with a structured light system to obtain article 3-dimensional information;
processing the article 3-dimensional information to determine the minimum number of scans necessary to scan the surface of the as-made aircraft part;
directing a laser beam at a surface of the as-made aircraft part to create ultrasonic surface displacements, wherein the laser beam is directed at the surface of the article according to processed 3-dimensional information to minimize the number of scans necessary to scan the surface of the as-made aircraft part;
detecting the ultrasonic surface displacements;
correlating the as-made aircraft part 3-dimensional information with the ultrasonic surface displacements;
comparing the as-made aircraft part 3-dimensional information with a known data set;
processing the ultrasonic surface displacement data;
correlating the known data set and the processed ultrasonic surface displacements to provide coordinate measurements for the ultrasonic surface displacement data of the as-made aircraft part;
storing the as-made aircraft part 3-dimensional information and the ultrasonic surface displacement data;
installing the as-made aircraft part onto an aircraft;
scanning the installed aircraft part with a structured light system to obtain article 3-dimensional information;
processing the article 3-dimensional information to determine the minimum number of scans necessary to scan the surface of the installed aircraft part;
directing a laser beam at a surface of the installed aircraft part to create ultrasonic surface displacements, wherein the laser beam is directed at the surface of the article according to processed 3-dimensional information to minimize the number of scans necessary to scan the surface of the as-made aircraft part;
directing a laser beam at a surface of the installed aircraft part to create ultrasonic surface displacements;
detecting the ultrasonic surface displacements;
correlating the installed aircraft part 3-dimensional information with the ultrasonic surface displacements;
processing the ultrasonic surface displacement data;
correlating the known data set and the processed ultrasonic surface displacements to provide coordinate measurements for the ultrasonic surface displacement data; and
comparing the installed aircraft part 3-dimensional information and processed ultrasonic surface displacement data and the as-made aircraft part 3-dimensional information and processed ultrasonic surface displacement data.

14. The method of claim 13 wherein the evaluation of the aircraft part includes the identification of a defect selected from the group consisting of delamination, cracks, inclusions, disbands, and combinations thereof.
